(19) United States
(12) Patent Application Publication
(10) Pub. No.: US 2008/0091806 A1
(43) Pub. Date: Apr. 17, 2008

(54) Dynamic On-Demand Clustering

(76) Inventors: Jinmei Shen, Rochester, MN (US); Hao Wang, Rochester, MN (US)

Correspondence Address: WOOD, HERRON & EVANS, L.L.P. (IBM), 2700 CAREW TOWER, 441 VINE STREET, CINCINNATI, OH, 45202, US

(21) Appl. No.: 11/548,351

(22) Filed: Oct. 11, 2006

(51) Int. Cl. G06F 15/173

(52) U.S. Cl. 709/223

(57) ABSTRACT

An apparatus, program product and method utilize on-demand clustering to handle client requests received by a clustered computer system. With on-demand clustering, clusters of nodes may be dynamically created in response to requests to perform work received from clients of a clustered computer system. By doing so, a clustered computer system often may be capable of adapting more easily to handle diverse and various types of workloads that may be unknown at the time of deployment of the clustered computer system.

### FIELD OF THE INVENTION

The invention is generally directed to clustered computing systems, and in particular, to the establishment of clusters in clustered computing systems.

### BACKGROUND OF THE INVENTION

Distributed computing systems have found application in a number of different computing environments, particularly those requiring high performance and/or high availability and fault tolerance. In a distributed computing system, multiple computers connected by a network are permitted to communicate and/or share workload. Distributed computing systems support practically all types of computing models, including peer-to-peer and client-server computing.

One particular type of distributed computing system is referred to as a clustered computing system. “Clustering” generally refers to a computer system organization where multiple computers, or nodes, are networked together to cooperatively perform computer tasks. An important aspect of a computer cluster is that all of the nodes in the cluster present a single system image—that is, from the perspective of a client or user, the nodes in a cluster appear collectively as a single computer, or entity. In a client-server computing model, for example, the nodes of a cluster collectively appear as a single server to any clients that attempt to access the cluster.

Clustering is often used in relatively large multi-user computing systems where high performance and reliability are of concern. For example, clustering may be used to provide redundancy, or fault tolerance, so that, should any node in a cluster fail, the operations previously performed by that node will be handled by other nodes in the cluster. Clustering is also used to increase overall performance, since multiple nodes can often handle a larger number of tasks in parallel than a single computer otherwise could. Often, load balancing can also be used to ensure that tasks are distributed fairly among nodes to prevent individual nodes from becoming overloaded and therefore maximize overall system performance. One specific application of clustering, for example, is in providing multi-user access to a shared resource such as a database or a storage device, since multiple nodes can handle a comparatively large number of user access requests, and since the shared resource is typically still available to users even upon the failure of any given node in the cluster.

In many clustered computer systems, multiple clusters may be established to perform different types of operations and/or to provided different types of services for clients. These clusters typically include as members all or a subset of the nodes or servers in the clustered computer system. In addition, any given node may participate in more than one cluster.

Conventional clustering architectures are typically based upon a client-server architecture, and moreover, the clustering and routing technologies used thereby are typically server-centric. With a server-centric methodology, the number of nodes in a clustered computer system, as well as the number and sizes of clusters in such a system, is often established statically, and based upon an enterprise's expected load requirements. Furthermore, in many instances, the types of requests that clusters may be expected to handle are fairly homogenous in nature, and can be handled equally well by any of the nodes in a clustered computer system. While the configuration of a clustered computer system can often be altered to address performance issues (e.g., to add another server to increase system workload capacity), such configuration often requires significant effort and oversight by a systems administrator.

With the development of web services, service-oriented architecture (SOA), and utility computing, however, the types of requests that clustered computer systems may be expected to handle are expected to come from diverse parties and differ from one other significantly, and as a result, conventional clustering techniques often fall short of providing suitable overall performance. SOA and utility computing in particular effectively decouple the traditional client/server model upon which conventional clustering techniques are typically based. In conventional client/server computing, clients are tightly coupled with servers; however, in SOA and utility computing, clients are decoupled with servers. It has been found, for example, that the gateway architecture relied upon in many clustered computer systems, where client requests are handled by a gateway/router that routes the requests to appropriate nodes in a cluster, does not provide adequate scalability or availability when used in connection with SOA and utility computing.

Conventional clustering techniques are, as noted above, static and server-centric, and in many respects lack sufficient flexibility to account for the wide variety of services that a clustered computer system may need to provide. As a result, the configuration of a clustered computer system to optimally handle various types of requests from different sources can be problematic and difficult to manage. It has been found that in many instances the manner in which client requests are routed to appropriate nodes or servers in a clustered computer system, as well as the manner in which such requests are ultimately handled by such nodes or servers, can have a significant impact on overall system performance, workload capacity and responsiveness to client requests.

Therefore, a significant need exists in the art for a faster and more efficient manner of managing clusters and handling client requests in a clustered computer system.

### SUMMARY OF THE INVENTION

The invention addresses these and other problems associated with the prior art in providing an apparatus, program product and method that utilize on-demand clustering to handle client requests received by a clustered computer system. With on-demand clustering, clusters of nodes may be dynamically created in response to requests to perform work received from clients of a clustered computer system. By doing so, a clustered computer system often may be capable of adapting more easily to handle diverse and various types of workloads that may be unknown at the time of deployment of the clustered computer system. As such, in SOA, utility computing, and like environments, on-demand clustering often presents a substantially more flexible and adaptive clustering architecture than is provided by conventional server-centric clustering architectures.

Therefore, consistent with one aspect of the invention, requests may be processed in a clustered computer system by receiving a request to perform work in the clustered computer system, and, in response to the request, dynamically creating a cluster of at least a subset of a plurality of nodes to handle the request.

Consistent with another aspect of the invention, a method of deploying an on-demand clustering service is provided, which includes deploying program code for installation in a clustered computing environment. The program code that is deployed is configured to process requests to a clustered computer system by initiating a dynamic creation of a cluster of at least a subset of a plurality of nodes in the clustered computer system in response to a request to perform work in the clustered computer system.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a clustered computing system incorporating on-demand clustering consistent with the invention.

FIG. 2 is a flowchart illustrating the program flow of an exemplary request handling routine capable of being executed by a client in the clustered computing system of FIG. 1.

FIG. 3 is a flowchart illustrating the program flow of an exemplary request handling routine capable of being executed by a server in the clustered computing system of FIG. 1.

FIG. 4 is a flowchart illustrating the program flow of an exemplary response handling routine capable of being executed by a client in the clustered computing system of FIG. 1.

FIG. 5 is a flowchart illustrating the program flow of an exemplary cluster/context data synchronization routine capable of being executed by a server in the clustered computing system of FIG. 1.

FIG. 6 is a flowchart illustrating the program flow of an exemplary master server capacity manager routine capable of being executed by a server in the clustered computing system of FIG. 1.

FIG. 7 is a flowchart illustrating the program flow of an exemplary slave server capacity manager routine capable of being executed by a server in the clustered computing system of FIG. 1.

FIGS. 8 and 9 are block diagrams of an exemplary clustered computing system, illustrating a plurality of dynamically created clusters and the adaptation of the clustered computing system to changes in system workload.

### DETAILED DESCRIPTION

The embodiments described hereinafter provide on-demand clustering that dynamically creates and adapts clusters in a clustered computer system based upon the requests for work received from clients of the clustered computer system. In contrast with a number of traditional clustering techniques, on-demand clustering is more client-centric, such that clusters may be dynamically created on an as needed basis, and based upon the volume and types of requests for work issued by clients of a clustered computer system. As a result, clients and servers are not required to be as tightly coupled as is found in a client-server model. Furthermore, on-demand clustering provides a more flexible and efficient model for use with SOA, utility computing, and other computing models that are less dependent upon underlying hardware platforms. Among other benefits, on-demand clustering is readily adaptable to handle diverse and various clients that are unknown before a clustered computer system is deployed.

On-demand clustering may be used, for example, to provide client-centric and policy-based server resource management. In the illustrated embodiments, for example, one server can deploy multiple different resources, several servers can deploy the same resource, and each server can have totally different resource set than another servers. Also, in the illustrated embodiments, each resource can be activated or deactivated independently according to clients interest and according to server policy.

Embodiments consistent with the invention are capable of dynamically creating a cluster of at least a subset of a plurality of nodes in a clustered computer system (herein also referred to as an inflight cluster) in response to a request to perform work in the clustered computer system. A request for work, issued by a client, is a request for some service such as access to a resource being managed by a clustered computer system, and may be directed toward any type of service or resource capable of being provided by a clustered computer system. Typically, but not necessarily, a request is intercepted by a router, disposed within the client or alternatively in another computing device, and mapped to a cluster capable of servicing the request. If no cluster capable of servicing the request is found to exist, embodiments consistent with the invention dynamically create an appropriate cluster that includes one or more nodes from the clustered computer system. Otherwise, if an appropriate cluster exists, the request may be routed by the router to a suitable node in the cluster.

In the embodiments discussed in greater detail below, cluster-supported services and/or resources are categorized into categories, with clusters established to handle different categories. Incoming requests are mapped to categories based upon a comparison of context data associated with the request and that of different categories. Services or resources may be categorized in a number of different manners, and may be based, for example, upon rules set by an administrator that specify attributes related to various types of request contexts. Request contexts may have attributes such as request resources, request type, request parameters, user type, and client origin, among others. The rules may be configured by each enterprise according to enterprise policy. Thus, for example, a bank might classify its customers (and thus the requests issued by such customers) into categories according to their importance to the bank, or according to different geographical regions, e.g., North America, Asia, etc. Categories may also be established based upon other contexts, e.g., resource type, resource location, etc.

In addition, in some embodiments of the invention, the client-centric approach provided by on-demand clustering permits the workload capacity and resource allocation of a clustered computer system to be dynamically adapted based upon the workload being generated by clients of the system. Embodiments consistent with the invention may be capable of monitoring the workload of individual servers and of individual clusters, as well as overall system workload. Based upon such performance metrics, the membership of clusters may be modified to add or remove nodes as needed, resources may be reallocated between nodes and clusters, and new clusters can be created and old clusters destroyed as appropriate for maintaining optimal system performance.

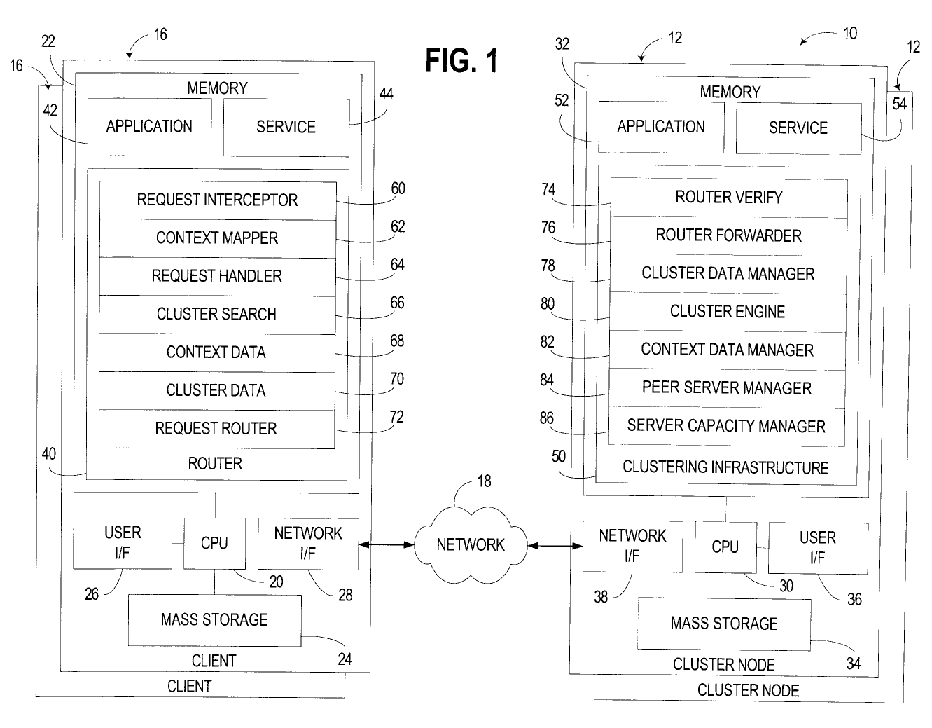

Turning to the Drawings, wherein like numbers denote like parts throughout the several views, FIG. 1 illustrates an exemplary clustered computing system 10 suitable for implementing on-demand clustering consistent with the invention. FIG. 1, in particular, illustrates a plurality of nodes 12 in clustered computer system 10 that are coupled to a plurality of clients 16 over a network 18. A node 12 typically resides on a single physical computer, e.g., a server-type computer, although it will be appreciated that a multiple nodes may reside on the same physical computer in some embodiments, e.g., in a logically-partitioned computer. The terms “node” and “server” are used interchangeably herein, and as such, it will be appreciated that a given computer in a clustered computer system can be considered to host one or more nodes or servers in a particular clustering environment.

Each node 12 is typically implemented, for example, as any of a number of multi-user computers such as a network server, a midrange computer, a mainframe computer, etc. Each client 16 likewise is typically implemented as any of a number of single-user computers such as workstations, desktop computers, portable computers, and the like. It will be appreciated, however, that any of the nodes 12 or clients 16 may alternatively be implemented using various multi-user or single-user computers, as well as in various other programmable electronic devices such as handheld computers, set top boxes, mobile phones, etc. Particularly when utilized in a service oriented architecture or utility computing architecture, practically any networkable device that is capable of accessing and/or providing a computing service may be utilized in a clustered computing environment consistent with the invention.

Each client 16 generally includes a central processing unit (CPU) 20 including one or more system processors and coupled to a memory or main storage 22, typically through one or more levels of cache memory (not shown). Furthermore, CPU 20 may be coupled to additional peripheral components, e.g., mass storage 24 (e.g., a DASD or one or more disk drives), various input/output devices (e.g., a control panel, display, keyboard, mouse, speaker, microphone, and/or dedicated workstation, etc.) via a user interface 26, and one or more networks 18 via a network interface 28. Likewise, each node 12 typically includes a CPU 30, memory 32, mass storage 34, user interface 36 and network interface 38 that are similarly configured to each client, albeit typically with components more suited for server-type or multi-user workloads. Any number of alternate computer architectures may be used for either clients or nodes in the alternative.

Each client 16 and node 12 is further configured to host various clustering-related software components that are utilized to support on-demand clustering. For example, client 16 incorporates a router component 40 that is used to interface one or more client applications or services 42, 44 with a clustered computer system. Each node 12, in turn, includes a clustering infrastructure component 50 that communicates with the router 40 in each client to provide the clients with access to various cluster-hosted applications and/or services 52, 54. The router 40 and clustering infrastructure 50 may be implemented in various manners within a client or node, including, for example, within a kernel or operating system, within a middleware component, within a device driver, or in other manners that will be apparent to one of ordinary skill having the benefit of the instant disclosure. In one implementation, for example, the router 40 and clustering infrastructure 50 are implemented in Java, e.g., in the WebSphere Network Deployment or eXtended Deployment editions.

The discussion hereinafter will focus on the specific routines utilized to implement the above-described policy management functionality. The routines executed to implement the embodiments of the invention, whether implemented as part of an operating system or a specific application, component, program, object, module or sequence of instructions, will also be referred to herein as “computer program code,” or simply “program code.” The computer program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to physical recordable type media such as volatile and nonvolatile memory devices, floppy and other removable disks, hard disk drives, optical disks (e.g., CD-ROM's, DVD's, etc.), among others, and transmission type media such as digital and analog communication links.

In addition, various program code described hereinafter may be identified based upon the application or software component within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

The invention may also include the deployment of suitable program code to implement on-demand clustering in a clustered computing environment. Such deployment may include the deployment of program code to one or more servers and/or one or more clients, and may include automatic or automated installation of such program code. For example, deployment may include on-demand installation of program code in a client in response to that client attempting to connect to a clustered computer system. The deployment may include the transmission of program code over a transmission medium and/or may incorporate the loading and installation of program code via an external storage device.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

In the illustrated embodiment, on-demand clustering is implemented using a router 40 that resides within each client 16 along with a clustering infrastructure 50 that resides in each node 12. The functions associated with implementing on-demand clustering in router 40 are illustrated in FIG. 1 as components 60-72, while the on-demand clustering functions implemented by clustering infrastructure 50 are illustrated as components 74-86.

Router 40 includes a request interceptor component 60 that intercepts each client request to extract context data from the request. The context data may include any data associated with a request that may be useful in connection with categorizing the request and routing the request to an optimal server or cluster. Context data may include, for example, the type of service requested, other request parameters, user or client address, request class, request method, request method attributes, custom-defined parameters, and request time, among others.

A context mapper component 62 then takes the extracted context data and maps the request into one or more discrete categories that different nodes or clusters can handle. A request handler component 64 then encapsulates the request into an appropriate context and network format that includes, for example, routing information such as a long value epoch of the current client routing table cache and current client context data, where the routing table includes the cluster name and server endpoints of clustered servers, and where each server endpoint includes protocol (e.g., IIOP, HTTP, TCP, etc.), host, port, etc. The request handler in the illustrated embodiment also keeps track of the epoch, or version, of cluster data and context data in the request and its later response, and imports any update of cluster data and/or context data embedded in a response into a local cache for the client. The request handler may also be used to insert a client's local epoch of cluster and/or context data into the request stream.

A cluster search component 66 is used to search cluster data in a local cache for the client to assist in locating an appropriate cluster to which a request should be routed. The cluster data may include any type of data associated with the configuration of one or more clusters in a clustered computer system, e.g., cluster name, context data associated with a cluster, accepted request types, operation policies, thresholds, member histories, cluster members, and cluster load statistics, among others. Cluster data may also include local cluster data for particular cluster members, e.g., capacity data, current load, host machine, host, port, accepted request types, and availability, among others.

The aforementioned context data and cluster data may be stored, respectively, in context data and cluster data components or data structures 68, 70. Components 68, 70 may also include local caches, or may themselves be considered to be local caches for the respective data.

Router 40 also includes a request router component 72 that handles the actual routing of client requests to nodes or servers in a matching cluster, or alternatively, to any available node or server in the event that the request is subsequently forwarded to another appropriate node or server.

For cluster infrastructure 50 on each node 12, a router verify component 74 is used to check the context data for an incoming client request with the node's service capacity, and if no match occurs, to locate an appropriate node for the request and forward the request to the appropriate node using a router forwarder component 76. The router verify component 74 and/or router forwarder 76 may also be used to insert a new epoch of cluster data and/or context data into the response stream returned to a client.

Cluster infrastructure 50 also includes a cluster data manager component 78, which is used to manage the cluster data for the node. The cluster data manager component 78 may also include functionality for creating and merging cluster data from peer servers or nodes. A cluster engine component 80 is used to create, destroy, and otherwise manage clusters. Among other operations, cluster engine component 80 is capable of creating a new cluster for a request context whenever router verify component 74 receives a “null” cluster in the request, as well as to propagate new cluster data and context data into other servers with the assistance of peer server manager component 84.

A context data manager component 82 is used to manage context data for both requests and categories or clusters. Component 82 is capable, for example, of merging context data received from a client in a request with existing context data stored in the node, and increasing the epoch number (e.g., a machine time, timestamp, version number, or other identifier capable of being used to distinguish one “snapshot” of context data from another). Component 82 is also desirably capable of transferring merged context data back into clients through the response stream.

A peer server manager component 84 is used to communicate data with peer server managers on other nodes or servers to synchronize cluster data and context data between peer servers. A server capacity manager component 86 is used to manage the capacity for a node or server either individually or in conjunction with server capacity managers on other nodes. As will be discussed in greater detail below, for example, the server capacity manager components 86 in multiple nodes may be used to generate an optimal deployment of resources and services between nodes or services across a clustered computer system. Among other functions, a server capacity manager component 86 may be used by a cluster engine component 80 during the creation of an inflight cluster for a new category or request context.

It will be appreciated that the partitioning of functionality between components 60-84 may vary in different embodiments, and that the functionality may be incorporated into greater or fewer numbers of components. It will also be appreciated that the partitioning of functionality between clients and nodes/servers may also vary in different embodiments. It will also be appreciated that router 40 and clustering infrastructure 50 may include additional functionality that is not relevant to on-demand clustering, but which is not discussed in greater detail herein. Therefore, the invention is not limited to the particular implementation described herein.

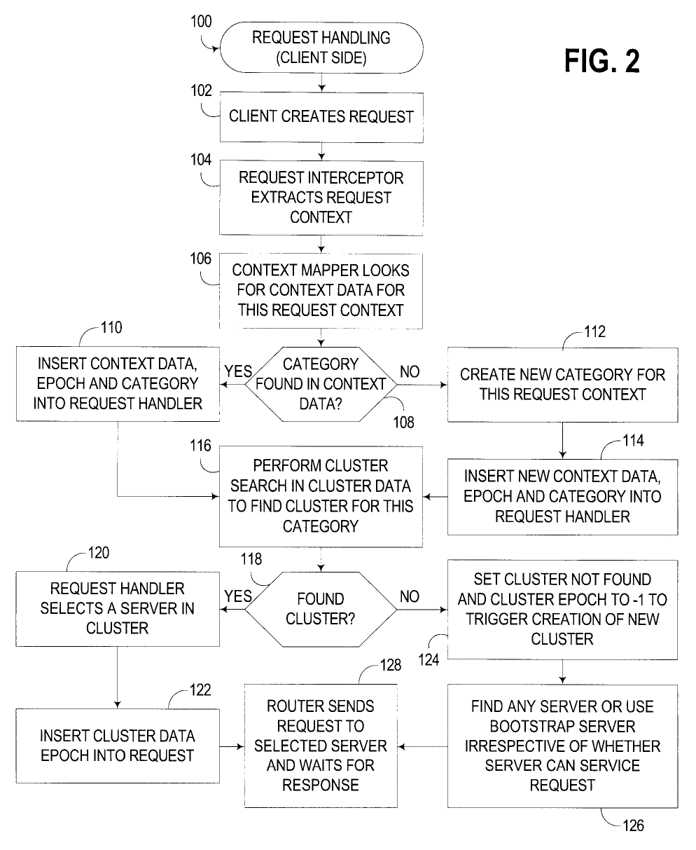

FIG. 2 illustrates a request handling routine 100 implemented by a client and the router resident in such client to request work to be performed by a clustered computer system. Routine 100 begins in block 102, where the client, e.g., an application or service resident on the client, creates a request for work. The request is typically a request for some cluster-provided service, and may vary widely in different applications. The request is also typically not a request that specifics any particular service associated with managing the clustering capabilities of the clustered computer system. Put another way, the request is not a request in the nature of a request to manage the operation of the clustered computer system, but is instead a request to have work performed for the client. In other embodiments, however, a client may be permitted to directly request the creation of a cluster, or perform other associated operations, in a clustered computer system.

Next, in block 104 request interceptor component 60 intercepts the request and extract the relevant context data from the request. Next, in block 106 context mapper component 62 then attempts to map the request to one of a plurality of categories by comparing the context data in the request with the context data for one or more established categories. Categories may be defined in a number of manners consistent with the invention, and may be based upon different types of context data, including combinations of context data. For example, categories may be based upon the type of service requested, request priority, request origin, request type, request method, request parameter (for example, a request to buy 10,000 shares of stock could be distinguished and/or prioritized over another request to buy 1 share of stock), or any other type of context data that may be associated with a request. It will be appreciated that mapping rules may be configurable by an administrator so each enterprise can handle different requests in different fashions.

Block 108 next determines whether the context data for the request maps to a category, and if so, passes control to block 110 to insert or pass the context data for the request, the current epoch, and the found category to request handler component 64. Otherwise, block 108 passes control to block 112 to create a new category for the request, and to block 114 to insert or pass the new context data, the current epoch, and the new category to the request handler component.

Upon completion of either of block 110 or 114, control passes to block 116 where a cluster search is performed by cluster search component 66 to locate a cluster for the selected category, based upon the cluster data maintained in component 70. If an appropriate cluster is found, block 118 passes control to block 120, where request handler component 64 selects a server or node in the selected cluster. Control then passes to block 122 to insert the current cluster data epoch into the request to provide the clustered computer system with an updated copy of the cluster data maintained by the client. It will be appreciated that the selection of a server by the request handler component may be implemented in a number of manners consistent with the invention, e.g., using various load balancing algorithms such as random selection, round robin selection, load-based selection, weight-proportional selection (e.g., where a weight is assigned to each server based upon available CPU and/or memory), or using other algorithms such as static assignment of clients to particular servers.

Returning to block 118, if no appropriate cluster is found, control passes to block 124 to set a “cluster not found” indicator in the request and set the cluster epoch to “−1” (or another suitable unique value) to notify the clustered computer system of the need to create a new cluster. Control then passes to block 126 to select a server to receive the request, e.g., via any of the aforementioned algorithms used to select a server in block 120, or alternatively, via the selection of a bootstrap server. Unlike in block 120, however, the selected server need not provide the service sought in the request, since no current cluster has been determined to be suitable to handle the request.

Upon completion of either block 122 or block 126, control passes to block 128, where the router, and in particular request router component 72 sends the request to the selected server. The client then waits for a response from the server.

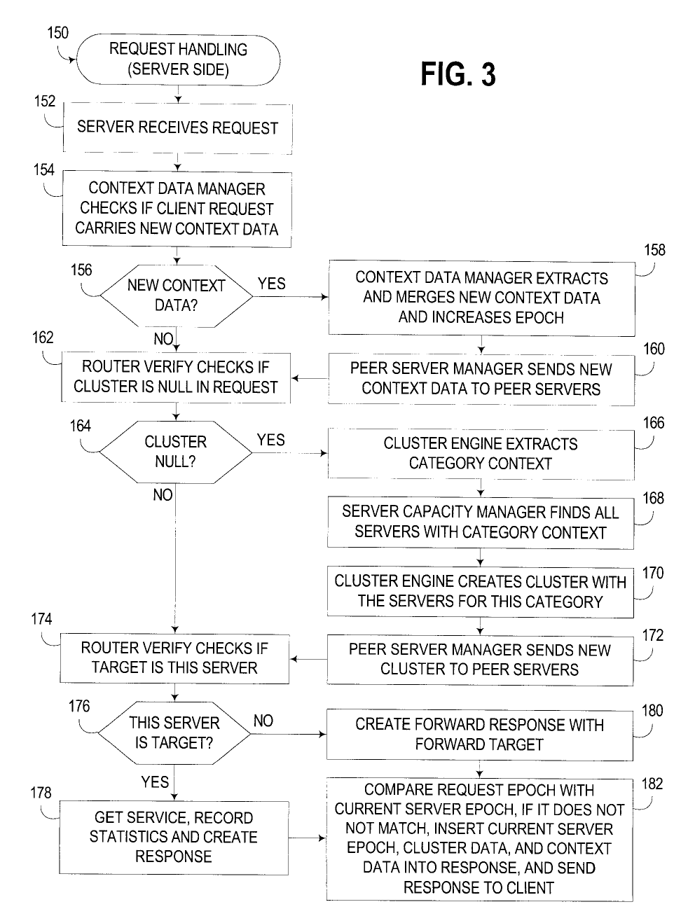

FIG. 3 illustrates a request handling routine 150 implemented by a server and the clustering infrastructure resident in such server to process requests received from clients. Routine 150 begins in block 152, where the server receives the request.

Next, in block 154, context data manager component 82 determines whether the request includes new context data, e.g., by checking the epoch of the context data in the request verses that of the server. If so, block 156 passes control to block 158, where the context data manager extracts and merges the new context data with the context data already stored on the server or node, and increases the epoch (version) identifier for the context data. Then, in block 160, peer server manager component 84 sends the new context data to the other nodes or servers to synchronize the context data amongst the servers. It will be appreciated that various manners of synchronizing data among nodes in a cluster may be used to synchronize the context data, as will be appreciated by one of ordinary skill in the art having the benefit of the instant disclosure.

Upon completion of block 160, or if block 156 determines that no new context data is included in the request, control passes to block 162, where router verify component 74 determines whether the cluster identified in the request is “null”, indicating that the router for the client determined that no cluster exists to handle request.

If so, block 164 passes control to block 166, where cluster engine component 80 extracts the context data associated with the category specified in the request. Next, in block 168, the server capacity manager component 86 locates all or at least a subset of the servers in the clustered computer system that are capable of servicing requests associated with the specified category. Next, in block 170, the cluster engine component creates a new cluster using all or a subset of the servers located in block 168. Then, in block 172, peer server manager component 84 sends the cluster data associated with the new cluster to the other servers in the clustered computer system.

Upon completion of block 172, or if block 164 determines that the identified cluster is not null, control passes to block 174, where router verify component 74 determines whether the target server for the request is the local server that the component is running on. If so, control passes to block 178 to get the requested service (e.g., by passing the request to the requested service or application on the server). Block 178 also records any statistics associated with processing the request (e.g., request count, CPU, memory, response time, throughput, error count, and waiting time, among others), and creates the appropriate response. Otherwise, block 176 passes control to block 180 to create a “forward” response identifying the appropriate target server to handle the request (e.g., a server in a newly created cluster). Upon completion of either of blocks 178 or 180, control passes to block 182 to send the response to the client. In addition, block 182 compares the request epoch (version) with the current server epoch, and if the epochs don't match, the current server epoch, along with the current cluster and context data, is inserted into the response prior to the response being sent to the client in order to enable the client to update its local cache of cluster and context data.

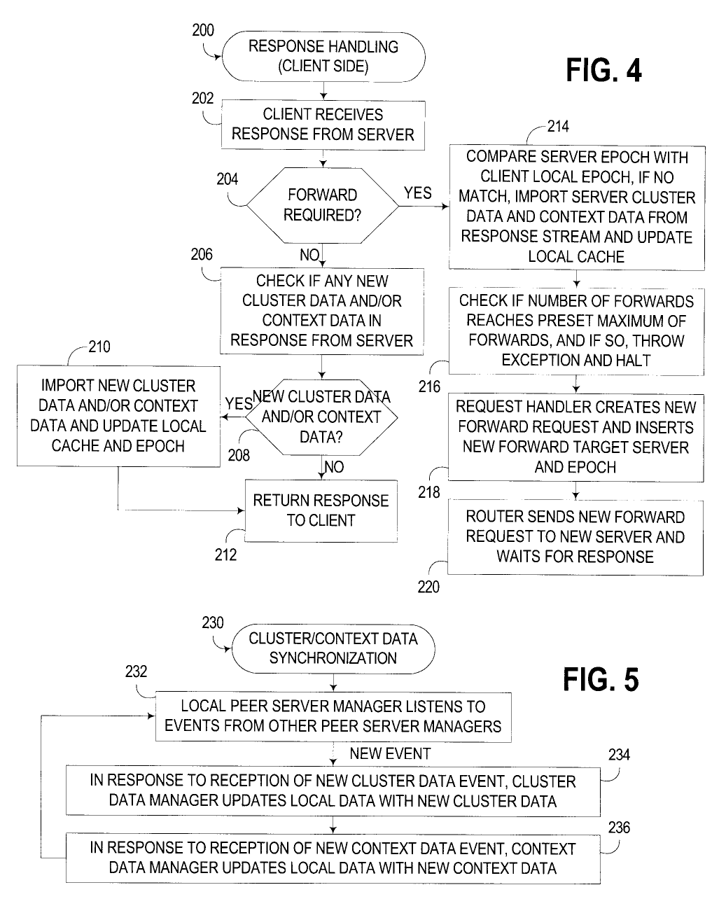

FIG. 4 next illustrates a response handling routine 200 implemented by a client and the router resident in such client to process a response received from a server responsive to a work request issued by the client. Routine 200 begins in block 202, where the client receives the response from the server. Block 204 then determines whether a forward of the request is required, i.e., whether the response is a “forward” response that indicates that the request needs to be resent to another server.

If not, control passes to block 206 to check if any new cluster and/or context data is included in the response. If so, block 208 passes control to block 210 to import the new cluster and/or context data into the local copies of such data maintained by components 68, 70, and to update the epoch for the data to that specified in the response. Control then passes to block 212 to return the response to the client application or service, whereby processing of the response is complete. In addition, returning to block 208, if no new cluster and/or context data is included in the response, control passes directly to block 212 to return the response to the client application or service.

Returning to block 204, if a forward is required, control passes to block 214 to compare the server epoch (as specified in the response) with that of the client. If the epochs do not match, the server cluster and/or context data as provided in the response is imported into the local copies of such data maintained by components 68, 70, and the epoch for the local data is updated to that specified in the response.

Next, block 216 checks if the number of forwards of the request has reached a preset maximum, and if so, halts processing of the request and throws an exception to the client application/server. Otherwise, control passes to block 218, where request handler component 64 creates a new request that specifies as the target server the server identified in the forward response. The request also specifies the current epoch for the client, in the event that the epoch has been updated as a result of data provided in the forward response. Then, in block 220, the router, and in particular request router component 72 sends the new forward request to the new target server and waits for a response. Handling of the response to the forward request is performed in the same manner as described herein.

As discussed above in connection with blocks 166 and 172 of FIG. 3, any update to context and/or cluster data in one server/node is replicated to other servers/nodes in the clustered computer system. As shown in FIG. 5, for example, a cluster/context data synchronization routine 230 may be executed by each server. Routine 230 executes in a loop initiated by block 232, where the local peer server manager component 84 for the server listens for events from the peer server manager components of other servers. In response to a new event, control then passes to blocks 234 and 236 to respectively process new cluster data events and new context data events. For a new cluster data event, cluster data manager component 78 is called in block 234 to update the local cluster data in the server with the data provided in the event. Likewise, for a new context data event, context data manager component 82 is called in block 236 to update the local context data in the server with the data provided in the event.

As also discussed above in connection with block 168 of FIG. 3, each cluster engine component 80 relies on a server capacity manager component 86 during the creation of an inflight cluster for a new category or request context. In one exemplary implementation, the server capacity manager components 86 in nodes or servers 12 are used to cooperatively generate an optimal resource allocation plan for the clustered computer system. Furthermore, these components 86 may be used to dynamically and adaptively adjust the resource allocation plan to address workload variations experienced by the clustered computer system. For example, in one exemplary implementation, server capacity manager components 86 may themselves be arranged into a cluster, with one such component 86 elected as a master server capacity manager that distributes an optimal plan to the other components 86, functioning as slaver server capacity managers.

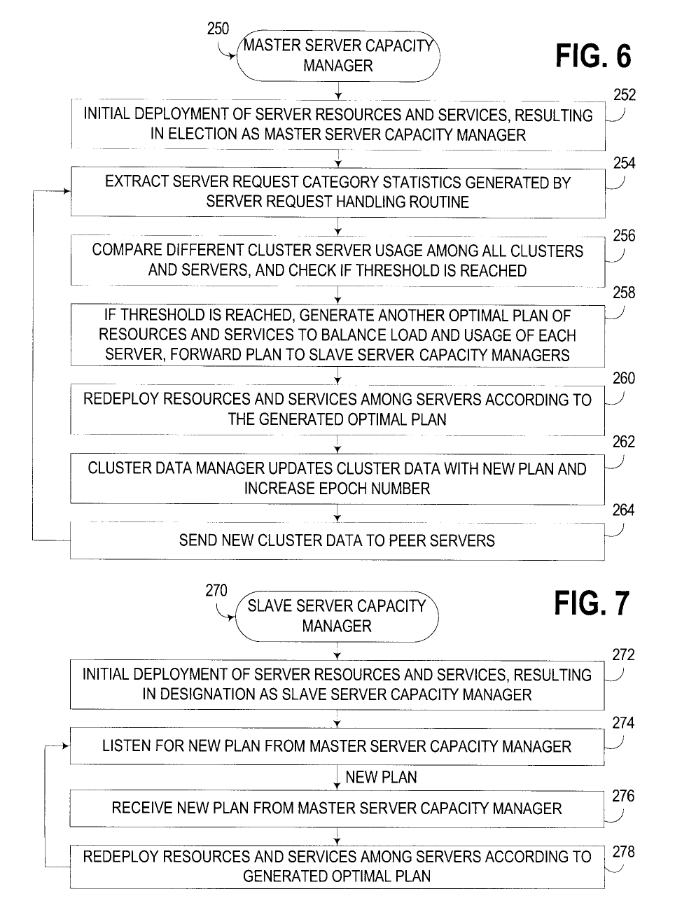

As shown in FIG. 6, for example, a master server capacity manager routine 250 may be executed by a node in the cluster having a master server capacity manager component resident on the node. Routine 250 begins in block 252 by initially deploying server resources and services according to an initial resource allocation plan. The initial resource allocation plan may be generated in a number of manners, e.g., dynamically based upon the first request of each category, by initial distribution according to historical request data, by manual input by an administrator when no historical data is available, etc. In addition, in block 252 the server capacity manager components collectively elect a master server capacity manager, using any number of available election strategies, e.g., based upon server address or name. The remainder of the server capacity manager components are initially designated as slave server capacity managers, and it will be appreciated that failover functionality may be supported to enable a slave server capacity manager to assume the role of a master in the event of a failure in the master.

Routine 250 continues in block 254 by extracting server request category statistics that have been generated by the server-side request handling routine, e.g., at block 178 of FIG. 3. Block 256 then compares different cluster server usage statistics among all existing clusters and servers, and makes a determination as to whether a threshold has been reached. The threshold may be based upon any number of performance metrics, e.g., overall cluster load, overall system load, individual server load, usage statistics regarding each cluster (e.g., time since last use, frequency of use, etc.), throughput, response time, idle period, etc., and is used to determine when some performance characteristic associated with the clustered computer system is sub-optimal.

If the threshold is reached, block 258 then generates another optimal resource allocation plan to better balance the load and usage across the clustered computer system, e.g., using any of the techniques that may be used to generate the initial plan. The master server capacity manager component then forwards the new optimal plan to the slave server capacity manager components on the other nodes of the clustered computer system to update the desired plan on the other nodes. Next, block 260 redeploys the resources and services on the local node according to the generated optimal plan. In connection with such redeployment, various operations may be performed. For example, nodes may be added to or removed from clusters to adjust the workload capacity of a cluster based upon current workload requirements. In addition, standby nodes or other resources (e.g., additional processors, additional memory, etc.) may be added or removed from the clustered computer system. As another example, unused or infrequently used clusters may be destroyed. Other types of operations that may be performed during redeployment include resource/application version updates, new application add-ins, old application removals, host changes, etc., as well as any other operations that may be used to manage the workload and resource allocation of the nodes in a clustered computer system.

Next, in block 262 cluster data manager component 78 updates the cluster data stored in the node with the cluster data associated with the new plan, and increases the epoch number for the cluster data to reflect a state change in the cluster data. Block 264 then sends the new cluster data to the other servers in the clustered computer system via the peer server manager components 84 on the servers. Control then returns to block 254 to continue to monitor the performance of the clustered computer system and dynamically adapt the resource allocation plan as necessary.

For a node having a slave server capacity manager, a routine 270, as shown in FIG. 7, may be executed in lieu of routine 50. Routine 270 begins in block 272, which like block 252 of routine 250 initially deploys server resources and services according to an initial resource allocation plan. However, as a result of the same election process used in block 252, the server capacity manager is designated as a slave, and as a result, routine 270 proceeds to block 274 to listen for a new resource allocation plan forwarded by the master server capacity manager.

Upon receipt of a new plan, control passes to block 276 to receive the new plan from the master server capacity manager. Then, block 278 redeploys the resources and services on the server according to the new plan, in a similar manner to block 260 of routine 250. Control then passes to block 274 to continue to listen for new plans.

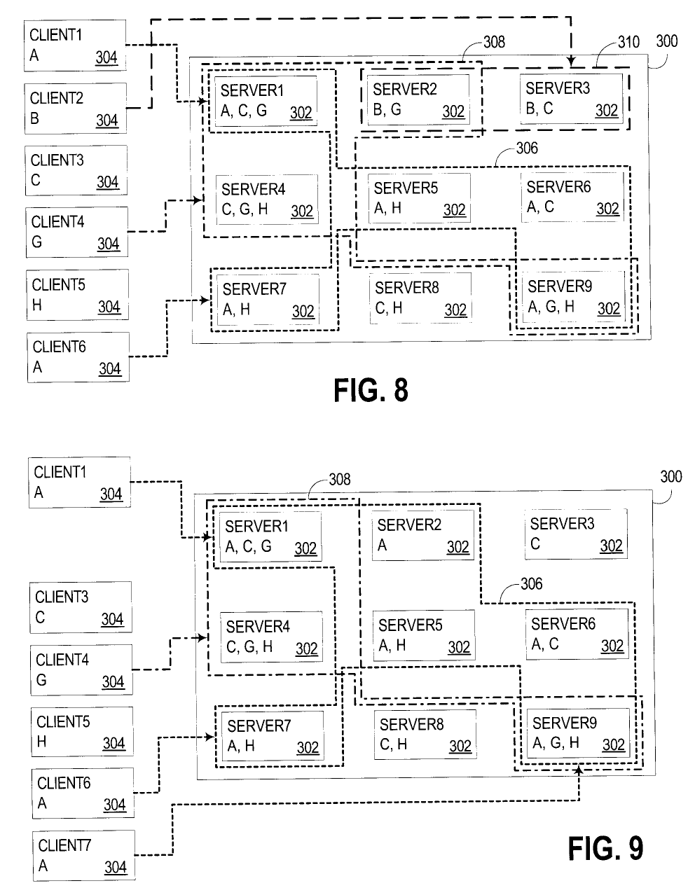

FIGS. 8 and 9 further illustrate the operation of a clustered computer system incorporating on-demand clustering. In particular, FIG. 8 illustrates an exemplary clustered computer system 300 including nine nodes or servers 302 (also designated as “SERVER1” to “SERVER9”) capable of supporting a plurality of services categorized into a plurality of categories designated as A, B, C, G and H. Also illustrated are a plurality of clients 304 (also designated as “CLIENT1” to “CLIENT6”) that are configured to access services provided by clustered computer system 300.

Assume, for example, that no clusters initially are established in clustered computer system 300. CLIENT1 initiates a request for service matching a category A. The client-side router for CLIENT1 will intercept the request, extract the context data for the request, and attempt to find a category for such context data. If, for example, no cluster has been established for category A, the request will designate a “null” cluster, and upon receipt by one of nodes 302, the clustering infrastructure on that receiving node will dynamically create an inflight cluster of servers having capacity to service requests associated with category A. For example, a cluster 306 may be created from servers SERVER1, SERVERS, SERVER6, SERVER7 and SERVER9, ultimately resulting in the routing of the request from CLIENT1 to one of the servers in cluster 306 for handling of the request.

Likewise, assume that other clients, e.g., CLENT2 and CLIENT4, initiate requests for services matching other categories, e.g., categories B and G, and that no clusters initially exist to service those types of requests. The client-side routers for CLIENT2 and CLIENT4 will intercept the requests, extract the context data for the requests, and determine that no clusters have been established for such categories. The requests will indicate as such, resulting in the clustering infrastructure on whichever nodes receive the requests dynamically creating inflight clusters of servers having capacity to service requests associated with categories B and G. For example, for category B, a cluster 308 may be created from servers SERVER2 and SERVER3, while for category G, a cluster 310 may be created from servers SERVER 1, SERVER2, SERVER4, and SERVER9. The request from CLIENT2 will then be handled by one of the servers in cluster 308, while the request from CLIENT4 will be handled by one of the servers in cluster 310.

Assuming that another client CLIENT6 later initiates a request for a service categorized in category A, the clicnt-side router for that client will map the request to category A, determine that cluster 306 exists to handle requests associated with category A, and route the request to an appropriate server from cluster 306.

Now turning to FIG. 9, the dynamic and adaptive nature of clustered computer system 300 is illustrated in greater detail. In particular, assume that a new client 304 (CLIENT7) arrives and begins issuing requests associated with category A, and that another client 304 (CLIENT2) is no longer issuing requests of category B to the clustered computer system. The master server capacity manager on one of the servers may, for example, determine that cluster 310 is no longer being used (e.g., by not being used for a predetermined amount of time or with a predetermined frequency), that the current membership of cluster 306 is overloaded, and that the current workload of cluster 308 is below the capacity of the cluster. As a result of such a determination, a new resource allocation plan may be generated, resulting in the dynamic destruction of cluster 310, as well as shifting the capacity of SERVER2 to more optimally handle the current workload of the clustered computer system by dynamically removing SERVER2 from cluster 308 and adding it to cluster 306.

It will be appreciated that various modifications may be made to the illustrated embodiments without departing from the spirit and scope of the invention. For example, a router consistent with the invention need not be implemented directly within a client, but instead may be resident on a different computer that is accessible by a client. A router may also be capable of serving as a request/response handler for multiple clients, e.g., similar in nature to a network router or gateway. Furthermore, it will be appreciated that the terms client and server are relative within the context of the invention, as the client-server relationship described herein is more in the nature of a caller-callee relationship. In many architectures such as n-tier architectures, for example, a server may act as a client when calling other servers.

In addition, various manners of synchronizing cluster and/or context data among servers, nodes and clients other than that described herein may be used in the alternative.

Other modifications will be apparent to one of ordinary skill in the art. Therefore, the invention lies in the claims hereinafter appended.

What is claimed is:

1. A method of processing requests in a clustered computer system of the type including a plurality of nodes, the method comprising:
receiving a request to perform work in a clustered computer system; and
in response to the request, dynamically creating a cluster of at least a subset of the plurality of nodes to handle the request.

2. The method of claim 1, further comprising determining whether another cluster currently exists to handle the request, wherein dynamically creating the cluster is performed in response to determining that no other cluster currently exists to handle the request.

3. The method of claim 2, further comprising mapping the request to one of a plurality of categories, and wherein dynamically creating the cluster includes dynamically creating a cluster associated with a category to which the request is mapped.

4. The method of claim 1, further comprising dynamically destroying an unused cluster.

5. The method of claim 4, wherein dynamically destroying the unused cluster is performed in response to determining that the unused cluster has not been used for a predetermined amount of time or with a predetermined frequency.

6. The method of claim 1, further comprising monitoring a performance metric for the cluster and dynamically adding a node to the cluster based upon the monitored performance metric.

7. The method of claim 1, wherein dynamically creating the cluster is initiated by a router that receives the request.

8. An apparatus, comprising:
at least one processor; and
program code configured to be executed by the at least one processor to process requests in a clustered computer system of the type including a plurality of nodes by receiving a request to perform work in the clustered computer system and, in response to the request, dynamically creating a cluster of at least a subset of the plurality of nodes to handle the request.

9. The apparatus of claim 8, further comprising a router coupled to the plurality of nodes in the clustered computer system and configured to route the request to a cluster infrastructure in the clustered computer system.

10. The apparatus of claim 9, wherein the router is disposed in a client coupled to the clustered computer system, and wherein the client is configured to generate the request.

11. The apparatus of claim 8, wherein the processor and program code are disposed in a first node in the clustered computer system, the apparatus further comprising a second node.

12. The apparatus of claim 8, wherein the program code is further configured to determine whether another cluster currently exists to handle the request, and wherein the program code is configured to dynamically create the cluster in response to a determination that no other cluster currently exists to handle the request.

13. The apparatus of claim 12, wherein the request is mapped to one of a plurality of categories, and wherein the program code is configured to dynamically create the cluster by dynamically creating a cluster associated with a category to which the request is mapped.

14. The apparatus of claim 8, wherein the program code is further configured to dynamically destroy an unused cluster.

15. The apparatus of claim 14, wherein the program code is configured to dynamically destroy the unused cluster in response to a determination that the unused cluster has not been used for a predetermined amount of time or with a predetermined frequency.

16. The apparatus of claim 8, wherein the program code is further configured to monitor a performance metric for the cluster and dynamically add a node to the cluster based upon the monitored performance metric.

17. A method of deploying an on-demand clustering service, the method comprising:
deploying program code for installation in a clustered computing environment, the program code configured to process requests to a clustered computer system by initiating a dynamic creation of a cluster of at least a subset of a plurality of nodes in the clustered computer system in response to a request to perform work in the clustered computer system.

18. The method of claim 17, wherein deploying the program code includes deploying program code to a client of the clustered computer system.

19. The method of claim 17, wherein deploying the program code includes deploying program code to a node of the clustered computer system.

20. A program product, comprising:
program code configured to process requests in a clustered computer system of the type including a plurality of nodes by receiving a request to perform work in the clustered computer system and, in response to the request, dynamically creating a cluster of at least a subset of the plurality of nodes to handle the request; and
a computer readable medium bearing the program code.

21. The program product of claim 20, wherein the program code is further configured to determine whether another cluster currently exists to handle the request, and wherein the program code is configured to dynamically create the cluster in response to a determination that no other cluster currently exists to handle the request.

22. The program product of claim 21, wherein the request is mapped to one of a plurality of categories, and wherein the program code is configured to dynamically create the cluster by dynamically creating a cluster associated with a category to which the request is mapped.

23. The program product of claim 20, wherein the program code is further configured to dynamically destroy an unused cluster.

24. The program product of claim 23, wherein the program code is configured to dynamically destroy the unused cluster in response to a determination that the unused cluster has not been used for a predetermined amount of time or with a predetermined frequency.

25. The program product of claim 20, wherein the program code is further configured to monitor a performance metric for the cluster and dynamically add a node to the cluster based upon the monitored performance metric.
